(19) United States
(12) Patent Application Publication
(10) Pub. No.: US 2026/0186201 A1
(43) Pub. Date: Jul. 2, 2026

(54) OPTICAL FIBER THAT COMBINES AND DEMULTIPLEXES LIGHT

(71) Applicant: NTT, Inc., Tokyo (JP)

(72) Inventors: Yoko YAMASHITA, Musashino-shi, Tokyo (JP); Takayoshi MORI, Musashino-shi, Tokyo (JP); Kazuhide NAKAJIMA, Musashino-shi, Tokyo (JP); Taiji SAKAMOTO, Musashino-shi, Tokyo (JP); Takashi MATSUI, Musashino-shi, Tokyo (JP); Yuto SAGAE, Musashino-shi, Tokyo (JP); Hiroyuki IIDA, Musashino-shi, Tokyo (JP); Ryota IMADA, Musashino-shi, Tokyo (JP); Shinichi AOZASA, Musashino-shi, Tokyo (JP); Kohei OMOTO, Musashino-shi, Tokyo (JP); Taro IWAYA, Musashino-shi, Tokyo (JP)

(73) Assignee: NTT, Inc., Tokyo (JP)

(21) Appl. No.: 18/859,691

(22) PCT Filed: May 26, 2022
(86) PCT No.: PCT/JP2022/021533

§ 371 Date: Oct. 24, 2024

(51) Int. Cl. G02B 6/02; G02B 6/255

(52) U.S. Cl. CPC G02B 6/02095; G02B 6/022; G02B 6/255

(57) ABSTRACT

The present disclosure is an optical multiplexing/demultiplexing fiber having a core uniformly and continuously extending in a propagation direction; the fiber includes an optical waveguide for optically connecting one end face of the optical fiber and a side face of the core, in which an end part of the optical waveguide, on the side face side of the core, is coupled to the core.

### TECHNICAL FIELD

The present disclosure relates to an optical fiber capable of splicing optical fibers that are different in the number of cores.

### BACKGROUND ART

Various devices have been proposed to splice optical fibers that are different in the number of cores, such as a multi-core fiber and a single-core fiber (see, for example, NPL 1). In NPL 1, each core included in a multi-core fiber is connected to a separate single core fiber by utilizing a spatial optical system using a lens.

In NPL 1, since a spatial optical system is used, light needs extracting out of the optical fiber once. A device using such a spatial optical system has difficulty in being miniaturized.

### CITATION LIST

### Non Patent Literature

[NPL 1] ECOC2021 WelA. 4 (OPTOQUEST)
[NPL 2] OE vol. 23, No. 13, pp. 16760-16771

### SUMMARY OF INVENTION

### Technical Problem

An object of the present disclosure is to enable splice, between optical fibers that are different in the number of cores, in a compact configuration.

### Solution to Problem

An optical multiplexing/demultiplexing fiber according to the present disclosure is an optical multiplexing/demultiplexing fiber having a core in a cladding, including: an optical waveguide, for optically connecting one end face of the optical fiber and a side face of the core, in the cladding, in which an end part of the optical waveguide, on the side face side of the core, is coupled to the core.

An optical multiplexing/branching device according to the present disclosure includes the optical multiplexing/demultiplexing fiber of the present disclosure, and a multi-core fiber disposed on the one end face of the optical multiplexing/demultiplexing fiber, in which at least one core included in the multi-core fiber is connected to the optical waveguide included in the optical multiplexing/demultiplexing fiber.

In the optical multiplexing/demultiplexing fiber according to the present disclosure, the end part of the optical waveguide, on the side face side of the core, may be oblique to the core. In this regard, the optical multiplexing/demultiplexing fiber may further include a long period fiber grating (LPG) positioned at a coupling part of the core to the optical waveguide, and light having a wavelength or mode determined by the LPG may be coupled to the optical waveguide. Here, an angle of the oblique and a configuration of the optical waveguide may be determined depending on each component of the light to be coupled between the core and the optical waveguide and a light intensity of each component of the light. The LPG may be controllable by using a pressure applied thereto from an outer periphery of the cladding.

In the optical multiplexing/demultiplexing fiber according to the present disclosure, the end part of the optical waveguide, on the side face side of the core, may be a directional coupler arranged in parallel with the core. In this regard, a coupling length of the directional coupler and a configuration of the optical waveguide may be determined depending on each component of light to be coupled between the core and the optical waveguide and a light intensity of each component of the light.

The above disclosures can be combined where possible.

### Advantageous Effects of Invention

The present disclosure can enable splice, between optical fibers that are different in the number of cores, in a compact configuration.

### BRIEF DESCRIPTION OF DRAWINGS

FIG. 1 shows a configuration example in an optical multiplexing/demultiplexing fiber according to the present disclosure.

FIG. 2 shows an example of connection between the optical multiplexing/demultiplexing fiber and a multi-core fiber.

FIG. 3 shows an example of a configuration of optical waveguides.

FIG. 4 shows an example of a configuration of optical waveguides.

FIG. 5 shows an example of an optical multiplexing/branching device of the present embodiment.

FIG. 6 shows an example of an optical multiplexing/branching device of the present embodiment.

FIG. 7 shows a configuration example in an optical multiplexing/demultiplexing fiber according to the present disclosure.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

### First Embodiment

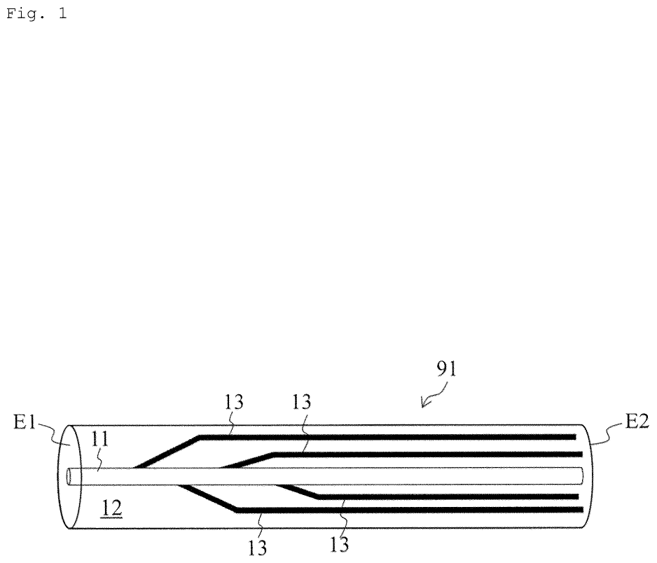

FIG. 1 shows a configuration example of an optical multiplexing/demultiplexing fiber according to the present disclosure. An optical multiplexing/demultiplexing fiber 91 of the present disclosure includes M (M=1) core(s) 11, which is(are) uniformly and continuously extending in a propagation direction, and optical waveguides 13, which optically connect an end face E2 and a side face of the core 11, in a cladding 12. In the present disclosure, each of the optical waveguides 13 is referred to as a tap waveguide. Each of the tap waveguides 13 is an optical waveguide capable of propagating light between a voluntarily selected position in a longitudinal direction of the core 11 and the end face E2. The tap waveguides 13 are configured to coincide with the positions of the cores, which are the connection destinations, within the emission end face E2.

The drawing shows an example in which the coupling positions of the core 11 to the respective tap waveguides 13 in the longitudinal direction are different depending on each of the tap waveguides 13, but the present disclosure is not limited thereto. For example, a plurality of tap waveguides 13 may be coupled to the same position of the core 11 in the longitudinal direction. Further, the configuration of the core 11 and the cladding 12, except the tap waveguides 13, can be any optical fiber. For example, the configuration may be a single-core or multi-core fiber, and may be a single-mode or multi-mode fiber, and the material may be any material. An example in which the core 11, included in the optical multiplexing/demultiplexing fiber 91, has a single propagation mode and the optical multiplexing/demultiplexing fiber 91 functions as an SMF will be described below.

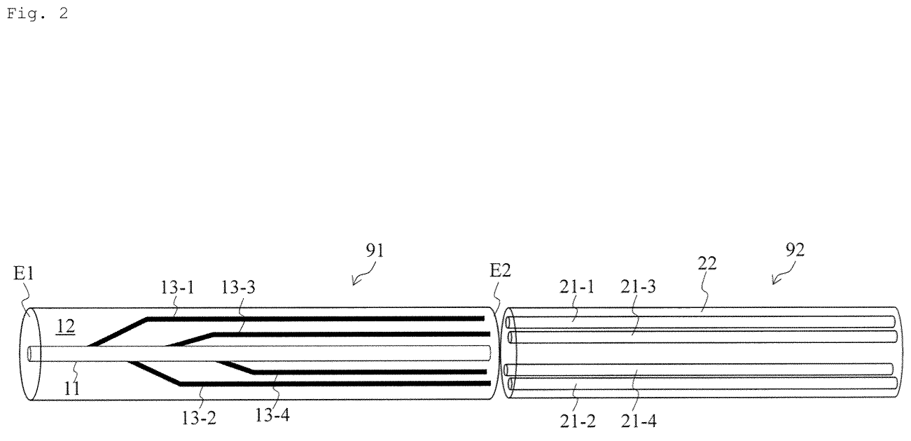

FIG. 2 shows an example of connection between the optical multiplexing/demultiplexing fiber 91 and the multi-core fiber 92. The optical multiplexing/demultiplexing fiber 91 of the present disclosure is an SMF, except for the tap waveguide 13. Hence, the end face E2 of the SMF is directly connected to an end face of the MCF 92, and the tap waveguide 13 is manufactured by using laser processing in the SMF (see, for example, NPL 2). Here, a femtosecond laser can be used for the processing. Thus, the optical multiplexing/demultiplexing fiber 91 of the present disclosure can be manufactured, and branches of one core 11 can reach the respective cores 21-1, 21-2, 21-3, and 21-4 included in the MCF 92.

The optical multiplexing/demultiplexing fiber 91 of the present disclosure has the following effects.
Light can be branched and connected from the SMF to the MCF 92 in a small size with low loss.
Space saving and handling are easy.
As will be described later, the wavelength, mode and power thereof can also be controlled.

The tap waveguides 13 can adopt any configuration capable of extracting light from the core 11. For example, for extracting light from the core 11, the following configurations can be used.
Configuration A: a combination of a long period fiber grating (LPG) and a tap waveguide
Configuration B: a directional coupler

### Second Embodiment

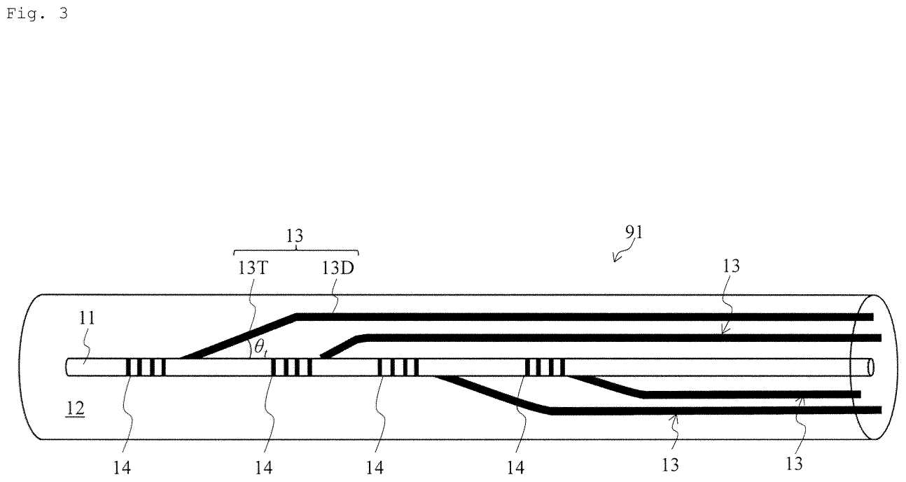

FIG. 3 shows a specific example of the configuration A. The core 11 is equipped with LPGs 14, and the tap waveguides 13 are coupled to parts of the core 11 at which the LPGs 14 are positioned. By adopting this configuration, the present disclosure can couple light having a wavelength or mode determined by each of the LPGs 14, among the propagation light inside the core 11, to the tap waveguide 13.

For example, when light is extracted from the core 11 by using one of the LPGs 14 and one of the tap waveguides 13, a center wavelength λ_{center} of the extracted light can be controlled by the pitch (Λ_{LPG}) of the LPG 14 in use. When the propagation modes of light inside the core 11 are an LP₀₁ mode and an LP₁₁ mode, the pitch Λ_{LPG} of the LPG 14 in use can be derived by using effective refractive indices (n_{eff_01}, n_{eff_11}) of the LP₀₁ mode and the LP₁₁ mode of the light propagated inside the core 11 and the center wavelength.

$$( Math . 1 )$$

$${Λ}_{LPG =} {λ}_{center} / ( {n}_{eff \_ 01} - {n}_{eff 11} ) \qquad ( 1 )$$

Each of the tap waveguides 13 includes an inclined section 13T that is oblique to the longitudinal direction of the core 11, and a waveguide section 13D for optically connecting the inclined section 13T and the end face E2. The inclined section 13T is coupled to the core 11. In this way, the end part of each of the tap waveguides 13, on the side face side of the core 11, is held at an oblique angle θt to the longitudinal direction of the core 11.

By adjusting the angle θt of the inclined section 13T and the waveguide configuration, each component of light, such as each coupling wavelength and each coupling mode to be coupled between the core 11 and the inclined section 13T, and a coupling light intensity of each component of the light can be adjusted. Here, the waveguide configuration of the inclined section 13T is a voluntarily selected parameter capable of changing a component of light to be coupled to the core 11 or coupling light intensity, and for example, the diameter, the refractive index or the length of the inclined section 13T can be exemplified.

In this way, in the present disclosure, controlling and extracting the wavelength, mode and coupling amount can be concurrently executed by using the written tap waveguides 13 oblique to the LPGs 14 and the core 11. Although the drawing shows an example in which the inclined section 13T and the waveguide section 13D are linear, the present disclosure is not limited thereto, and can adopt any shape corresponding to optical design. In addition, each of the LPGs 14 can be manufactured using the laser processing as well as each of the tap waveguides 13 can.

### Third Embodiment

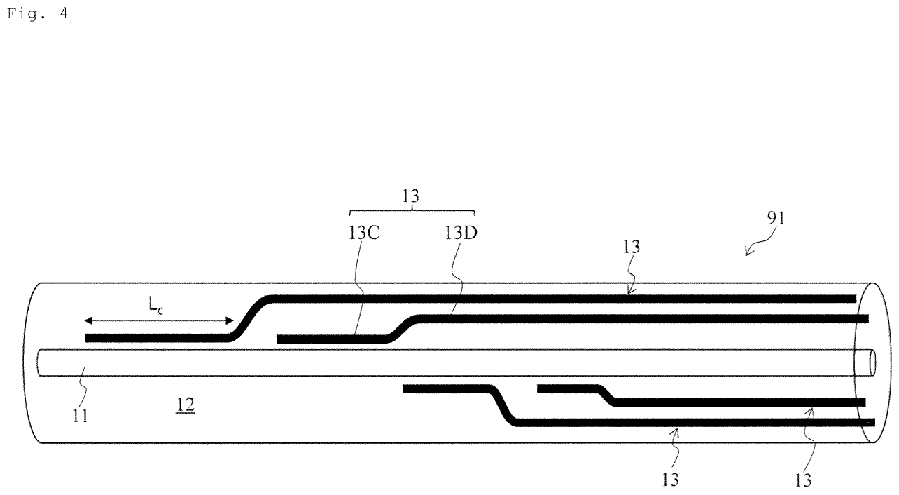

FIG. 4 shows a specific example of the configuration B. Each tap waveguide 13 includes a coupling section 13C coupled to the core 11, and a waveguide section 13D optically connecting the coupling section 13C and the end face E2. The coupling section 13C is a directional coupler arranged, in parallel to the core 11, at an interval capable of optically connecting to the side face of the core 11. By adopting this configuration, in the present disclosure, the light having the wavelength and mode coupled by the coupling section 13C, among the propagation light inside the core 11, can be coupled to the tap waveguide 13.

By adjusting a coupling length L_{C} and the waveguide configuration of the coupling section 13C, each component of light, such as each coupling wavelength and each coupling mode to be coupled between the core 11 and the coupling section 13C, and the coupling light intensity of each component of the light can be adjusted. For example, when a directional coupler is used for extracting light from the core 11, the wavelength and mode to be extracted can be controlled by changing the coupling length L_{C} of the coupling section 13C. Here, the waveguide configuration of the coupling section 13C is a voluntarily selected parameter capable of changing a component of light to be coupled to the core 11 or coupling light intensity, and for example, the diameter or the refractive index can be exemplified.

In this way, according to the present disclosure, a directional coupler can be formed by manufacturing a waveguide as the coupling section 13C, adjacent to the core 11, having a designated length, and then controlling and extracting the wavelength and the coupling amount can be concurrently executed as well as can be executed in the second embodiment. Although the drawing shows an example in which the coupling section 13C and the waveguide section 13D are linear, the present disclosure is not limited thereto, and can adopt any shape corresponding to optical design.

### Fourth Embodiment

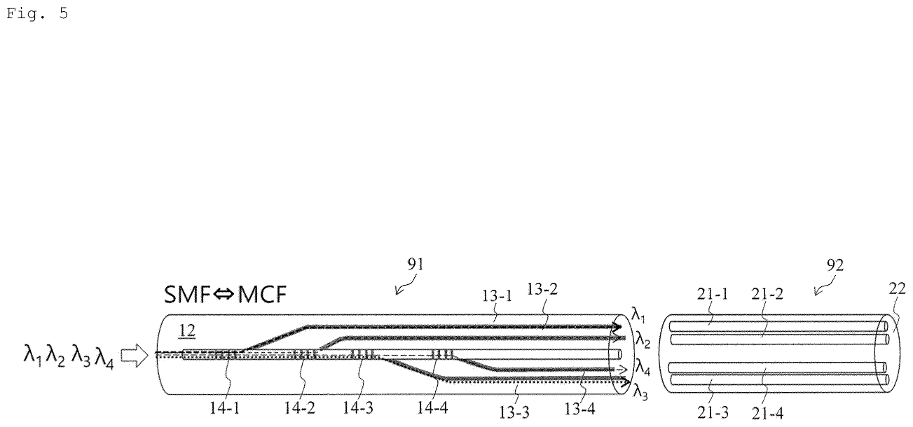

In the present embodiment, a configuration example of the optical multiplexing/demultiplexing device using the optical multiplexing/demultiplexing fiber 91 of the present disclosure will be described. FIG. 5 shows an example of a wavelength multiplexing/branching device according to the present embodiment using the above-mentioned configuration A.

In the configuration A, a wavelength or a mode can be selected by using each LPG 14, and light determined by each LPG 14 is coupled to the correspondent tap waveguide 13. Therefore, the optical multiplexing/demultiplexing device of the present embodiment has a function of bringing the wavelength or mode of light to be extracted under control of each tap waveguide 13 during extraction of light.

For example, the wavelengths allotted to the LPGs 14-1, 14-2, 14-3, and 14-4 are wavelengths λ1, λ2, λ3, and λ4, respectively. Thus, when the light having the wavelength λ1 propagates inside the core 11, the light having the wavelength λ1 can fork to the tap waveguide 13-1; when the light having the wavelength λ2 propagates inside the core 11, the light having the wavelength λ2 can fork to the tap waveguide 13-2; when the light having the wavelength λ3 propagates inside the core 11, the light having the wavelength λ3 can fork to the tap waveguide 13-3; and when light having the wavelength λ4 propagates inside the core 11, the light having the wavelength λ4 can fork to the tap waveguide 13-4.

In the present embodiment, the tap waveguides 13-1, 13-2, 13-3, and 13-4 are connected to the cores 21-1, 21-2, 21-3, and 21-4 of the multi-core fiber 92, respectively. Therefore, the optical multiplexing/demultiplexing fiber 91 can output the light having the wavelengths λ1, λ2, λ3, and λ4 propagating inside the core 11 to the cores 21-1, 21-2, 21-3, and 21-4, respectively.

Although the present embodiment shows an example in which the optical multiplexing/demultiplexing fiber 91 has the above-mentioned configuration A, the present disclosure is not limited thereto: the fiber 91 may have the configuration B.

### Fifth Embodiment

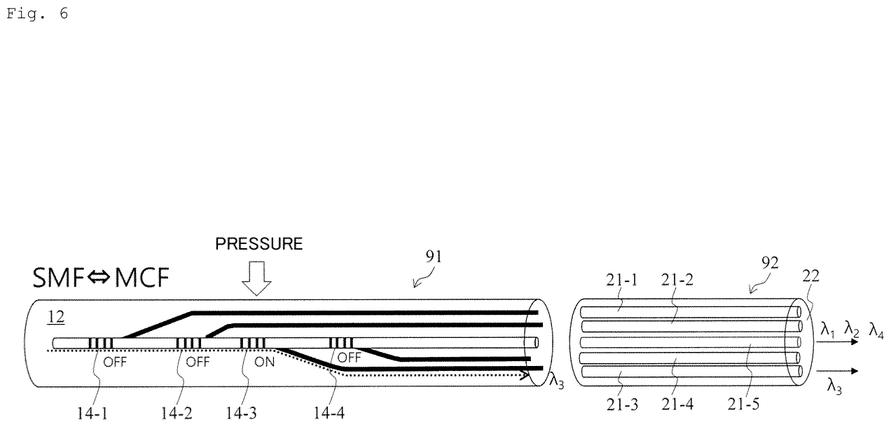

In the present embodiment, a switching mechanism for actively controlling the cores, which are the connection destinations, by using the optical multiplexing/demultiplexing fiber 91 of the present disclosure will be described. FIG. 6 shows an example of an optical multiplexing/demultiplexing device according to the present embodiment using the above-mentioned configuration A.

The description will be made by using an example in which the N core-MCF and the SMF are connected in the same way as these are connected in the fourth embodiment. The LPGs 14 can be actively controlled by applying pressure thereto from the outer periphery of a mechanical cladding 12 or the like. Therefore, in the present embodiment, the LPGs 14 are controlled actively, and only the LPG 14 disposed immediately before the tap waveguide 13 desired to be connected to the core 11 is operated.

For example, in the exemplification of the fourth embodiment, the LPGs 14-1, 14-2 and 14-4 are turned off not to operate, and the LPG 14-3 is turned on to operate. Thus, only the wavelength λ3 of the propagation light inside the core 11 can fork to the core 21-3.

The optical multiplexing/demultiplexing fiber 91 of the fourth embodiment is obtained by manufacturing the tap waveguides 13 is manufactured in an SMF. Therefore, the optical multiplexing/branching device of the present embodiment can switch the light, propagated from the SMF, to any of the cores 21-1, 21-2, 21-3, and 21-4 of the MCF 92.

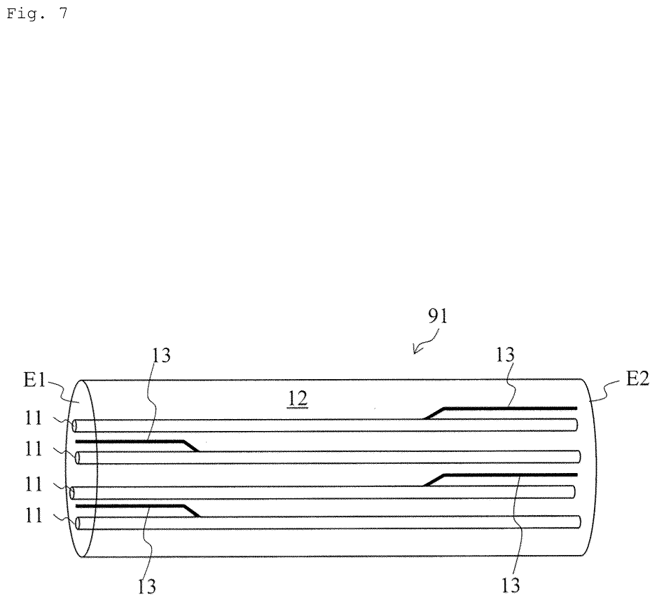

In the above-mentioned optical multiplexing/demultiplexing fiber 91, one core 11 is located in the cladding 12, but as shown in FIG. 7, two or more cores 11 may be located. Although the above-described optical multiplexing/demultiplexing fiber 91 exemplifies four tap waveguides 13 connected to one core 11, the number of tap waveguides 13 coupled to one core 11 may be any number equal to or more than one as shown in FIG. 7.

Although a configuration example in which the end parts of the tap waveguides 13 are gotten only into one end face E2 is shown, the end faces of the tap waveguides 13 may be distributed into the end faces E1 and E2 as shown in FIG. 7.

Thus, the present disclosure has no limitations on the number of cores of the optical multiplexing/demultiplexing fiber 91, and can also be used for splice between MCFs 92 having different numbers of cores. The connection from the MCF 92 to the SMF, namely in the reverse direction, can also be considered in the same manner. That is, coupling from each tap waveguide 13 to the core 11 can also be performed.
11, 21-1, 21-2, 21-3, 21-4, 21-5 Core
12 Cladding
13, 13-1, 13-2, 13-3, 13-4 Tap waveguide
13T Inclined section
13D Waveguide section
13C Coupling section
14, 14-1, 14-2, 14-3, 14-4 LPG
91 Optical multiplexing/demultiplexing fiber
92 MCF

1. An optical multiplexing/demultiplexing fiber having a core in a cladding, comprising:
an optical waveguide, for optically connecting one end face of the optical fiber and a side face of the core, in the cladding,
wherein an end part of the optical waveguide, on the side face side of the core, is coupled to the core.

2. The optical multiplexing/demultiplexing fiber according to claim 1, wherein the end part of the optical waveguide, on the side face side of the core, is oblique to the core.

3. The optical multiplexing/demultiplexing fiber according to claim 2, further comprising:
a long period fiber grating (LPG) positioned at a coupling part of the core to the optical waveguide,
wherein light having a wavelength or mode determined by the LPG is coupled to the optical waveguide.

4. The optical multiplexing/demultiplexing fiber according to claim 3, wherein an angle of the oblique and a configuration of the optical waveguide are determined depending on each component of the light to be coupled between the core and the optical waveguide and a light intensity of each component of the light.

5. The optical multiplexing/demultiplexing fiber according to claim 1, wherein the end part of the optical waveguide, on the side face side of the core, is a directional coupler arranged in parallel with the core.

6. The optical multiplexing/demultiplexing fiber according to claim 5, wherein a coupling length of the directional coupler and a configuration of the optical waveguide are determined depending on each component of light to be coupled between the core and the optical waveguide and a light intensity of each component of the light.

7. The optical multiplexing/demultiplexing fiber according to claim 3, wherein the LPG is controllable by using a pressure applied thereto from an outer periphery of the cladding.

8. An optical multiplexing/branching device comprising:
the optical multiplexing/demultiplexing fiber according to claim 1; and
a multi-core fiber disposed on the one end face of the optical multiplexing/demultiplexing fiber,
wherein at least one core included in the multi-core fiber is connected to the optical waveguide included in the optical multiplexing/demultiplexing fiber.
